(19) United States
(12) Patent Application Publication
(10) Pub. No.: US 2014/0068270 A1
(43) Pub. Date: Mar. 6, 2014

(54) Systems And Methods For Device Based Secure Access Control Using Encryption

(71) Applicant: Gurudatt Shenoy, Mumbai (IN)

(72) Inventor: Gurudatt Shenoy, Mumbai (IN)

(21) Appl. No.: 13/377,259

(22) PCT Filed: Aug. 9, 2011
(86) PCT No.: PCT/IB11/53541

§ 371 Date: Dec. 9, 2011

(30) Foreign Application Priority Data
May 20, 2011 (IN) 1545/MUM/2011

(51) Int. Cl. G06F 21/31

(52) U.S. Cl. CPC G06F 21/31
USPC 713/182

(57) ABSTRACT

The present invention in a preferred embodiment provides for systems and methods for ensuring and enabling secure access to one or more virtual locations or virtual data, by a user, wherein the said systems comprise of
a) at least one authentication device; and
b) at least one secondary device, wherein the secondary device may be a second authentication device or an access device;
   wherein an authentication device is associated with an authentication key which is used to generate an encrypted authentication code using a ‘unique device based encryption system and method’.

### FIELD OF THE INVENTION

The present invention relates to the field of encryption for data security or user identity protection or user authentication, in network based activities.

### BACKGROUND OF THE INVENTION

In the present age, networks of computing devices, for example internet, have become a popular and important medium for carrying out various day-to-day activities. In order to protect private or confidential data or information, there are systems developed to provide restricted access to one or more authorized users, one of the most common and widely used such systems being user authentication by multi-level user input such as a user name and password. As a general practice, a password is encrypted by the host server or service provider, for providing high security protection to the password or associated information from a hacker or any unauthorized user. However, even in such cases the password can be deciphered or decrypted using advanced techniques, as the encrypted password is stored in the host server, and a hacker may get access to it. This is one of the drawbacks of the known systems and methods relating to the field of user authentication, and the present invention aims to overcome this drawback.

Another need for today's age, especially in organizations and companies is to ensure secure access to data and information which may extend to personal level information or official or professional information, which at present cannot be effectively controlled and monitored.

Further, two or multi-level user input can often create hassles for a user, wherein the user may be using different passwords which creates confusion or error during any activity or transaction, due to which the user sometimes keeps the same password for different hosts or a simple and easily recallable password, which in turn makes the password weak and risks information and data security. It would be in the user's interest if the need of remembering or entering different passwords for different activities or hosts or domains is eliminated totally, which is one of the essential benefits provided by the present invention. This shall help the user carry out an effective password management through the present invention, and thus increase the overall security and effectiveness of the private or confidential data.

In the current state of art, certain additional external devices such as digital tokens or cards or dongle are provided to a user for additional security, which may become a liability for the user and also cause inconvenience. Alternately, methods such as biometric identification or iris identification are also employed for extremely high authentication level security. U.S. Pat. No. 7,506,174 to Brent L. Davis et al, is an example of an invention which discloses method and system for establishing a biometrically enabled password, as a means of additional security. The present invention eliminates the need of such extra or additional devices or methods. In fact, the systems of the present invention makes provisions for encryption based on the user's personal electronic device such as user's own mobile device or computer etc, which reduces inconvenience and also highly increase security because the device cannot be misused in the same manner as a password or electronic data can be. Also, when the said electronic device is lost or stolen or damaged the user will almost immediately know about such a scenario, while if a password is stolen or copied, it is possible that the user may not know it for a long period of time, or may not know about the scenario at all. This also makes the present invention more economical by eliminating the cost of extra steps or devices towards data or information security. The present invention also allows effective solutions to the vulnerability of losing rights or access to data and information if the said electronic device is lost, by allowing the option of multiple device registration with customized rights and privileges.

The present invention in its various embodiments addresses the above and other possible drawbacks and limitations of the currently used systems and methods relating to the field of user authentication, user identity protection and data access.

### SUMMARY OF THE INVENTION

In an aspect of the invention, systems and methods for ensuring and enabling secure access to one or more virtual locations or virtual data, by a user, is provided, wherein the said systems comprise of

a) at least one authentication device; and

b) at least one secondary device, wherein the secondary device may be a second authentication device or an access device;

wherein an authentication device is associated with an authentication key which is used to generate an encrypted authentication code using a ‘unique device based encryption system and method’.

In accordance with the present invention the ‘unique device based encryption system and method’ in an embodiment involves a user based input referred to as user key, and an electronic device key generated in connection with a user electronic device, preferably in real time, and an encryption algorithm or logic or program or software which uses the user key and device key to generate an encrypted authentication code.

In accordance with the present invention, a user key inputted from an authentication device is referred to as an authentication key, and a user key inputted from an access device is referred to as an access key, whether or not these keys are encrypted using the ‘unique device based encryption system and method’

In an embodiment of the invention, the ‘unique device based encryption system and method’ involves a system comprising of an encryption mechanism which generates an encrypted authentication code, wherein the encryption mechanism comprises of:

a) an authentication key;

b) an electronic device based unique key component;

c) an encryption algorithm;

d) one or more storage unit; and

e) one or more processing unit;

wherein the encrypted authentication code is made by using a suitable combination involving both authentication key and the electronic device based unique key component by encrypting both of the said components

### BRIEF DESCRIPTION OF THE DIAGRAMS

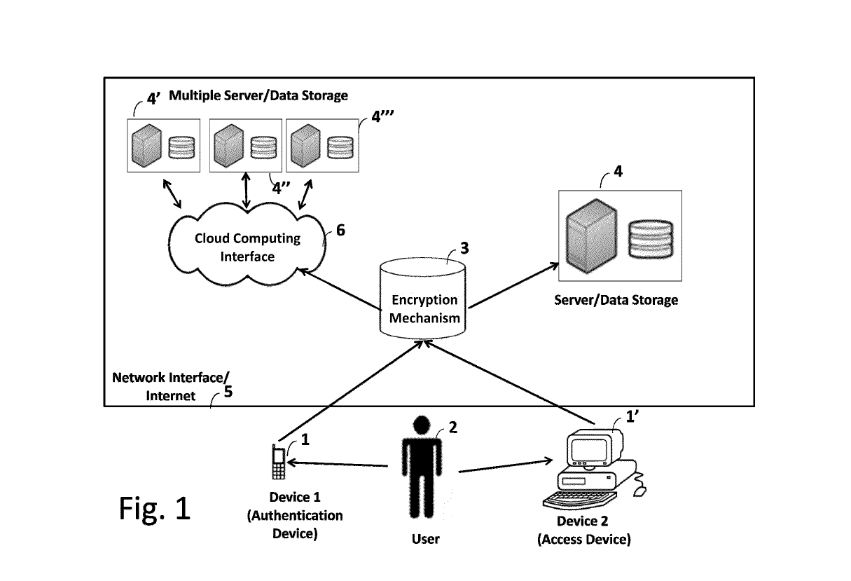

FIG. 1. is an illustrative example of the system diagram for the present invention involving a single user

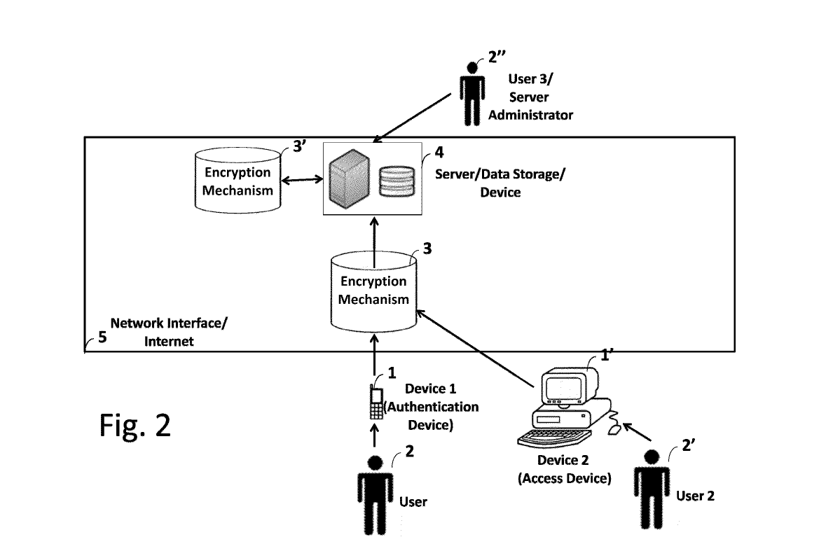

FIG. 2. is an illustrative example of the system diagram for the present invention involving a total of three users, two users at the client end and one user at the host server end.

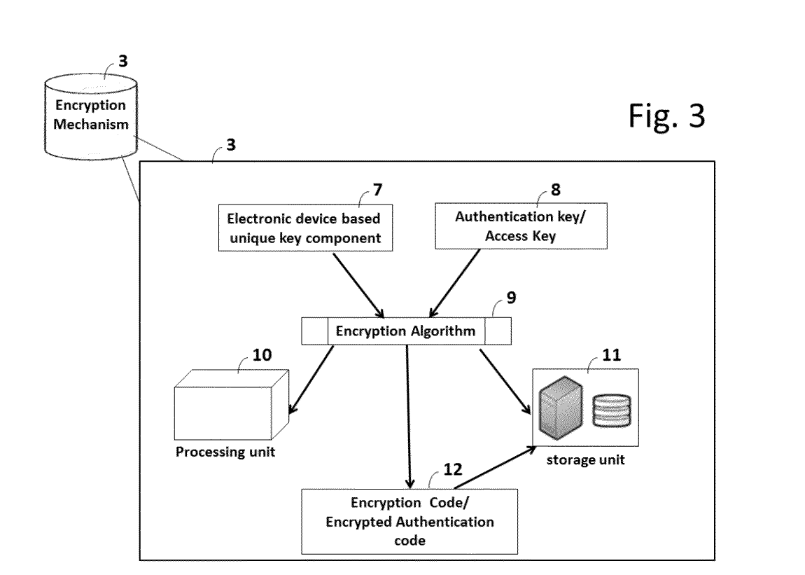

FIG. 3. represents a set of non-exhaustive and indicative components of the encryption mechanism in accordance one or more embodiment of the present invention.

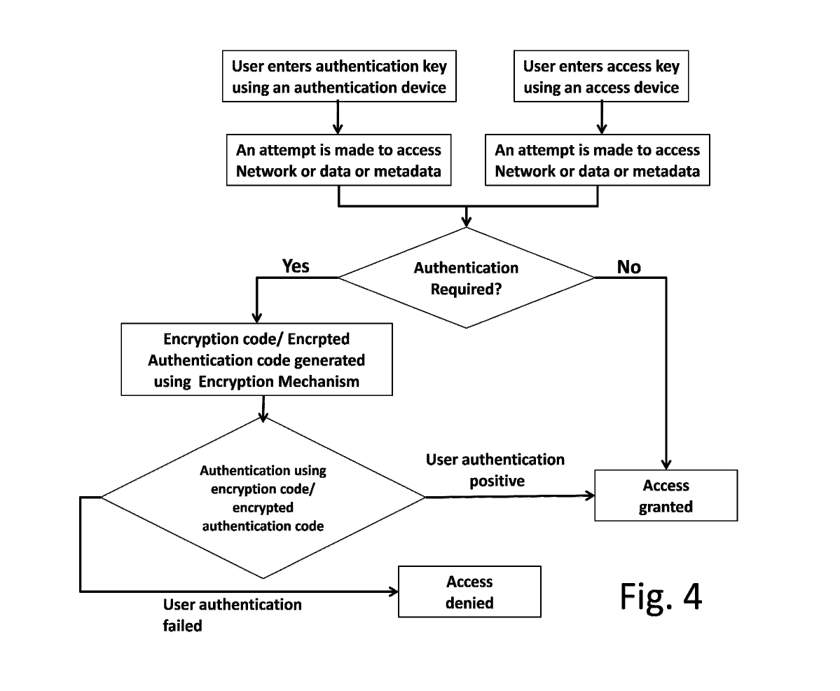

FIG. 4. represents an indicative system flow chart of an embodiment of the present invention.

### DETAILED DESCRIPTION OF THE INVENTION

The present invention in a preferred embodiment provides systems and methods for ensuring and enabling secure access to one or more virtual locations or virtual data, by a user, wherein the said systems comprise of

a) at least one authentication device; and

b) at least one secondary device, wherein the secondary device may be a second authentication device or an access device;

wherein an authentication device is associated with an authentication key which is used to generate an encrypted authentication code using a ‘unique device based encryption system and method’.

In an embodiment of the invention, the authentication device is an electronic device. The authentication device allows a user to control, enable or disable registration or access associated with other devices.

In an embodiment of the invention, the secondary device is an electronic device. The secondary device may be a second authentication device or an access device. The access device allows a user to access one or more virtual locations or virtual data but does not allow a user to control, enable or disable registration or access associated with other devices.

In an embodiment of the invention, the term key means a user input for the purpose of this invention. A user input associated with, or supposed to be entered using an authentication device is known as authentication key. A user input associated with, or supposed to be entered using an access device is known as access key.

In an embodiment of the invention, an authentication device is registered or associated with one or more virtual locations or virtual data using the ‘unique device based encryption system and method’ which involves the authentication key. After registration, the authentication device can be used to itself access and also control access to one or more virtual locations or virtual data.

In an embodiment of the invention, an authentication device can register or associate, or enable registration or association, of other access devices or other authentication devices.

In an embodiment of the invention, authentication of a user using the unique device based encryption system and method involving the authentication key and the electronic device based unique key is the necessary step to allow access to the authentication device as well as an access device. Once the user authentication is positive using the authentication key and authentication device, only then the access device may gain or give access to one or more virtual data or virtual location. In an embodiment of the invention, the terms ‘pairing of device’ or ‘dependency on device’ may be used to describe the association or relationship of the authentication device and access device.

In an embodiment of the invention, an authentication device may control or restrict or ensure denial or deletion or grant or enable

a. access to one or more virtual location or virtual data to any of one or more registered or non-registered access device, or to any of other authentication device, in any combination

b. registration of one or more of other access devices or authentication devices

In an embodiment of the invention, an authentication key is associated with an authentication device used for a first authentication step and an access key is associated with an access device used for a second authentication step, wherein the second authentication step is linked to and dependent upon the first authentication step. The authentication device is registered or associated with one or more virtual location or data, and the access device is registered or associated with one or more virtual location or data, wherein
a. one or more virtual location or data with which the authentication device is registered or associated may be the same as that of the one or more virtual location or data with which the access device is registered or associated; or
b. one or more virtual location or data with which the authentication device is registered or associated may be entirely different as that of the one or more virtual location or data with which the access device is registered or associated; or
c. one or more virtual location or data with which the authentication device is registered or associated may be partially same and partially different as that of the one or more virtual location or data with which the access device is registered or associated.
   In all of the aforementioned scenarios, while giving or getting access, a first authentication step takes place involving an authentication key and an authentication device and a ‘unique device based encryption system and method’, after which an authentication device can give or get access to one or more virtual location or data. After the said first authentication step takes place, a second authentication step may take place involving an access key and an access device and a ‘unique device based encryption system and method’, after which an access device can give or get access to one or more virtual location or data.

In an embodiment of the invention, an access device which is registered or associated with one or more virtual location or data, may or may not use an access key. In such a scenario, once the authentication is positive using the authentication key, the restriction or barrier for access by an access device may be released without the need for any access key, however since the access device is registered or associated with one or more virtual location or data, additionally the electronic device based unique key component is used for authentication or verification.

In an embodiment of the invention, an access device may or may not be registered or associated with a virtual location or virtual data for which user tries to get access or for which access is given. In such a scenario, once the authentication is positive using the authentication key, the restriction or barrier for access by an access device may be released without the need for any authentication.

In an embodiment of the invention, an access device may or may not use the ‘unique device based encryption system and method’ for getting or giving access to one or more virtual locations or virtual data.

In an embodiment of the invention, in case of multiple authentication devices, one of the several authentication devices may have excessive control power or administrative capacity in comparison to one or more of the other authentication devices.

In accordance with the present invention the ‘unique device based encryption system and method’ in an embodiment involves a user based input referred to as user key, and an electronic device key generated in connection with a user electronic device, preferably in real time, and an encryption algorithm or logic or program or software which uses the user key and device key to generate an encrypted authentication code.

In accordance with the present invention, a user key inputted from an authentication device is referred to as an authentication key, and a user key inputted from an access device is referred to as an access key, whether or not these keys are encrypted using the ‘unique device based encryption system and method’

In an embodiment of the invention, the ‘unique device based encryption system and method’ involves a system comprising of an encryption mechanism which generates an encrypted authentication code, wherein the encryption mechanism comprises of:

a) an authentication key;

b) an electronic device based unique key component;

c) an encryption algorithm;

d) one or more storage unit; and

e) one or more processing unit;

wherein the encrypted authentication code is made by using a suitable combination involving both authentication key and the electronic device based unique key component by encrypting both of the said components in one of the following ways or any combination thereof
i) Encrypting the authentication key and encrypting the electronic device based unique key component separately using the same encryption algorithm and then combining the two encrypted components with the same said encryption algorithm
ii) Encrypting the authentication key and encrypting the electronic device based unique key component separately using the same encryption algorithm and then combining the two encrypted components with a different encryption algorithm than the said encryption algorithm
iii) Encrypting the authentication key and encrypting the electronic device based unique key component separately using different encryption algorithms and then combining the two encrypted components with one of the said different encryption algorithms
iv) Encrypting the authentication key and encrypting the electronic device based unique key component separately using different encryption algorithms and then combining the two encrypted components with an entirely different encryption algorithm compared to the said different encryption algorithms
v) Combining the authentication key and the electronic device based unique key component and encrypting the combination with an encryption algorithm
vi) Encrypting the authentication key with an encryption algorithm and combining the encrypted component with the electronic device based unique key component and then encrypting the combination with the same said encryption algorithm.
vii) Encrypting the authentication key with an encryption algorithm and combining the encrypted component with the electronic device based unique key component and then encrypting the combination with a different encryption algorithm compared to the said encryption algorithm.
viii) Encrypting the electronic device based component with an encryption algorithm and combining the encrypted component with the single level user input unique key component and then encrypting the combination with the same said encryption algorithm.
ix) Encrypting the electronic device based component with an encryption algorithm and combining the encrypted component with the single level user input unique key component and then encrypting the combination with a different encryption algorithm compared to the said encryption algorithm.

In an embodiment of the invention, the one or more processing unit of the encryption mechanism may use the encryption algorithm for encryption or generation of an encrypted authentication code, or a processing unit may generate the electronic device based unique key component using device identity or device property.

In an embodiment of the invention, the one or more storage unit of the encryption mechanism may store one or more encryption algorithms, or a storage unit may store a component temporarily, or a storage unit may store an encrypted component temporarily, or a storage unit may store any data or metadata associated with a component or encrypted component temporarily.

In an embodiment of the invention, the authentication key and the electronic device based unique key component are deleted or removed from a storage unit instantaneously after temporary storage.

In an embodiment of the invention, the electronic device based unique key component or the electronic device based unique key component is not stored in any data storage device or server.

In an embodiment of the invention, the authentication key or the encrypted authentication key is not stored in any data storage device or server.

In an embodiment of the invention, there may be more than one storage units connected with each other as a part of an encryption mechanism. It may be possible that all of the mentioned storage devices are operational simultaneously, or only a few of the mentioned storage devices are operational simultaneously, or only one of the mentioned storage devices is operational simultaneously. This may be dependent on the operational requirement of the resources or the data storage device, or this may be done deliberately to misguide a hacker wherein different storage units may be either non-operational or they may be storing false or dummy data which even if hacked will not compromise the security of confidential or private information.

In an embodiment of the invention, there may be more than one processing units connected with each other as a part of an encryption mechanism. It may be possible that all of the mentioned processing devices are operational simultaneously, or only a few of the mentioned processing devices are operational simultaneously, or only one of the mentioned processing devices is operational simultaneously. This may be dependent on the operational requirement of the resources or the data processing device, or this may be done deliberately to misguide a hacker wherein different processing units may be either non-operational or they may be processing false or dummy data which even if hacked will not compromise the security of confidential or private information.

In an embodiment of the invention, the ‘unique device based encryption system and method’ involves a method for allowing a secure access control using an encryption mechanism which generates an encrypted authentication code, the method comprising of:
a) providing an authentication key by a user through an electronic device termed as ‘authentication device’ or an access key through an electronic device termed as ‘access device’;
b) acknowledging the authentication key or the access key by a processing unit;
c) using one or more properties of the electronic device or the identity of the electronic device by a processing unit to generate an electronic device based unique key component;
d) using a storage unit to temporarily store the electronic device based unique key component or authentication key or access key or a component generated in relation or the authentication key or access key, or both;
e) generating an encryption code or an encrypted authentication code by a processing unit using a suitable combination involving both, the said authentication key or access key, and the electronic device based unique key component;
f) storing the encryption code or encrypted authentication code using a storage unit; and
g) allowing the possibility of a secondary device which may be an access device or an authentication device to attempt access of one or more of virtual data or virtual location, which may be subjected to an authentication step.

In an embodiment of the invention, it may be required that the electronic device be registered or indexed with the encryption and identification program. As an addition or alteration to this embodiment, it may be required that the electronic device may meet certain predetermined parameters such as but not limited to having licensed version of software or operating system of the device, or an original device itself

In an embodiment of the invention, the algorithm or logic or program or code associated with encryption systems and methods may be maintained in a device which is separate from the device or server in which the encryption systems and methods are enabled.

In an embodiment of the invention, the provisions of the various embodiments of the present invention shall be applicable to an authentication device, even if no other access device is functional at the time of functioning of the authentication device

In an embodiment of the invention, the encryption algorithm may be different for different electronic devices.

In an embodiment of the invention the systems and methods of the present invention can be used and made applicable for any online or network based activities such as but not limited to monetary transactions, online shopping, social networks, emails, chatting, on-line gaming sessions, messaging, multimedia-conferencing, application-sharing, e-voting, group-ware & collaboration, blogging, or any combination thereof.

The term control access shall include both giving access and obtaining access.

The term virtual data shall include any data or information or program or software or code which can be stored or accessible or convertible in an electronic format.

In an embodiment of the invention, an authentication device may be a server or any other device or virtual location which is used to grant access to other users.

In an embodiment of the invention, the systems and methods of the present invention allow to get or give access to multiple virtual locations or virtual data simultaneously or by using a single sign-on feature or by a multiple-login feature.

The term ‘multiple location’ and multiple virtual location are, and can be, used interchangeably for the purpose of this invention, and shall include one or more of host networks or host servers or host websites or peer-to-peer systems or software in any combination thereof, which in any combination involves restricted or selective access.

In an embodiment of the invention, multiple devices can be registered or indexed in accordance with the present invention, and one or more of these devices can be used either individually or in combination thereof for using the systems and methods of the present invention.

In an embodiment of the invention, multiple levels of authentication may be used in addition to the preferred embodiment such as but not limited to domain name level identification, host server based identification and any other suitable identification mechanism.

In an embodiment of the invention, in addition to online or digital identification mechanisms, other mechanism such as but not limited to biometric or voice detection mechanisms may be used in accordance with the present invention. The term biometric can be interchangeably used with biometric authentication which consists of uniquely recognizing a user by way of authenticating distinctive individual characteristics such as but not limited to fingerprint marks, face recognition, DNA, palm print, hand geometry, iris recognition (which has largely replaced retina), and odour/scent.

In an embodiment of the invention, in addition to the systems and methods of the present invention illustrated in the various embodiments, the original electronic device key generated in connection with a user electronic device is stored by an authorized entity such as but not limited to government authorities, tax or auditing authorities or legally permitted authorities, in an authorized device or server, wherein the original electronic device key is encrypted and a second device key is generated in connection with the said authorized device or server, and a new authentication code is derived using combination of both the original device key and the second device key. This provision allows the authorized entities to prevent any misuse or breach of law, which may have a harmful or detrimental effect to the society or individuals of the society. Examples of such entities for the purpose of explanation and without limitation may be the IRS, FBI, CIA, State Police, Armed Forces, Federal Courts etc.

The systems of the present invention in an embodiment are made accessible through a portal or an interface which is a part of, or may be connected to, the internet or World Wide Web or any similar portal, wherein the portals or interfaces are accessed by one or more of users through an electronic device, whereby the user may send and receive data to the portal or interface which gets stored in at least one memory device or at least one data storage device or at least one server, and utilises at least one processing unit. The portal or interface in combination with one or more of memory device, data storage device, processing unit and serves, form an embedded computing setup, and may be used by, or used in, one or more of a computer program product. In an embodiment of the invention, the embedded computing setup and optionally one or more of a computer program product, in relation with, and in combination with the said portal or interface forms one of the systems of the invention. Typical examples of a portal or interface may be selected from but is not limited to a website, an executable software program or a software application.

A user is any person, machine or software that uses or accesses one or more of the systems or methods of the present invention. A user includes an automated computer program and a robot.

The term ‘encryption’ means the process of converting digital information into a new form using a key or a code or a program, wherein the new form is unintelligible or indecipherable to a user or a thief or a hacker or a spammer. The term ‘encryption’ includes encoding, compressing, or any other translating of the digital content. The encryption of the digital media content is performed in accordance with an encryption/decryption algorithm. The encryption/decryption algorithm utilized is not hardware dependent and may change depending on the digital content. For example, a different algorithm may be utilized for different websites or programs. The term ‘encryption’ further includes one or more aspects of authentication, entitlement, data integrity, access control, confidentiality, segmentation, information control, and combinations thereof.

In an embodiment of the invention, the said code may have a combination of numeric or alphanumeric or symbolic characters used for protected and restricted access provided to a user to one or more digital systems or function or data, provided after necessary authentication or identification of the user.

In an embodiment of the invention, the systems and methods can be practised using any electronic device. An electronic device for the purpose of this invention is selected from any device capable of processing or representing data to a user and providing access to a network or any system similar to the internet, wherein the electronic device may be selected from but not limited to, personal computers, mobile phones, laptops, palmtops, portable media players and personal digital assistants.

In an embodiment of the invention, the systems and methods of the present invention may be enabled through a computer program product which may be embodied in a computer.

The present invention in an embodiment, provides for a computer program product embodied in a computer readable medium that enables a system for ensuring and enabling secure access to one or more virtual locations or virtual data, by a user, wherein the said systems comprise of
a) at least one authentication device; and
b) at least one secondary device, wherein the secondary device may be a second authentication device or an access device;
   wherein an authentication device is associated with an authentication key which is used to generate an encrypted authentication code using a ‘unique device based encryption system and method’

In an embodiment of the invention, the encryption mechanism further comprises of one or more components which can be combined with one or more of other components of the mechanism in any combination, in an encrypted or unencrypted state, to generate an encryption key.

In an embodiment of the invention, one or more user can be blocked or denied access or be required to reattempt access, to one or more of the aspects of the invention.

In an embodiment of the invention, a user may have a system to record or send alert or be informed in case any other user is accessing the user's electronic device remotely.

In an embodiment of the invention, the systems and methods of the invention may simultaneously involve more than one user or more than one data storage device or more than one host server or any combination thereof.

In an embodiment of the invention, the systems and methods of the present invention are used to prevent or restrict hacking or related phenomenon such as but not limited to phishing, man in the middle attack, inside jobs, rogue access points, back door access, use of viruses and worms, use of trojan horses, denial of service attack, sniffing, spoofing, ransomware or any combination thereof

In an embodiment of the invention, a user may enter or communicate an authentication key or access key through any suitable input device or input mechanism such as but not limited to a keyboard, a mouse, a joystick, a touchpad, a virtual keyboard, a virtual data entry user interface, a virtual dial pad, a software or a program, a scanner, a remote device, a microphone, a webcam, a camera, a fingerprint scanner, a cave, pointing stick

In an embodiment of the invention the properties or programs or functions of a user electronic device may be selected from but is not limited to one or more of Internet Browser Properties, IP adress, MAC adress, Electronic Serial Numbers (ESNs), CPU number, globally unique identifier (GUID), universally unique identifier (UUID), International Mobile Equipment Identity or IMEI, IMEISV IMEI software version Mobile Equipment Identifier (MEID), International Mobile Subscriber Identity (IMSI number), MSISDN ('Mobile Subscriber ISDN Number' OR Mobile Station International ISDN Number), Mobile Equipment Identifier (MEID), server properties, and any other property or programs or functions or numbers which may be associated with a user electronic device.

In an embodiment of the invention, the systems and methods of the present invention provides or enables a user interface which may allow commands for a command line interface and/or a graphical user interface (GUI) enabling a user to create, modify and delete data or metadata or program or logic or algorithm or parameters associated with encryption method or encryption program or encryption language.

In an embodiment of the invention, the systems and methods can be practised using any electronic device which may be connected to one or more of other electronic device with wires or wirelessly which may use technologies such as but not limited to, Bluetooth, WiFi, Wimax. This will also extend to use of the aforesaid technologies to provide an authentication key or access key or electronic device based unique key or any combination thereof.

In an embodiment of the invention, the systems and methods of the present invention may use systems or interfaces of cloud computing, wherein for the purpose of this invention cloud computing would be any technology that uses a network and one or more remote servers to maintain data and applications.

In an embodiment of the invention, the systems and methods can be practised using any electronic device which may contain or may be infected by one or more of an undesirable software such as but not limited to a virus, or a Trojan, or a worm, malware, spyware, adware, scareware, crimeware, rootkit or any combination thereof

In an embodiment of the invention the system may involve software updates or software extensions or additional software applications.

In an embodiment of the invention, any form of internet security such as but not limited to, a firewall or antivirus or antimalware or registry protection can be used by a user in the same or different electronic device either simultaneously or separately, along with the systems or methods of the present invention.

In an embodiment of the invention one or more user can be blocked or denied access to one or more of the aspects of the invention.

The described embodiments may be implemented as a system, method, apparatus or article of manufacture using standard programming and/or engineering techniques related to software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fibre, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

In an embodiment of the invention computer program code for carrying out operations or functions or logic or algorithms for aspects of the present invention may be written in any combination of one or more programming languages which are either already in use or may be developed in future, such as but not limited to Java, Smalltalk, C++, C, Foxpro, Basic, HTML, PHP, SQL, Javascript, COBOL, Extensible Markup Language (XML), Pascal, Python, Ruby, Visual Basic .NET, Visual C++, Visual C# .Net, Python, Delphi, VBA, Visual C++.Net, Visual FoxPro, YAFL, XOTc1, XML, Wirth, Water, Visual DialogScript, VHDL, Verilog, UML, Turing, TRAC, TOM, Tempo, Tcl-Tk, T3X, Squeak, Specification, Snobol, Smalltalk, S-Lang, Sisal, Simula, SGML, SETL, Self, Scripting, Scheme, Sather, SAS, Ruby, RPG, Rigal, Rexx, Regular Expressions, Reflective, REBOL, Prototype-based, Proteus, Prolog, Prograph, Procedural, PowerBuilder, Postscript, POP-11, PL-SQL, Pliant, PL, Pike, Perl, Parallel, Oz, Open Source, Occam, Obliq, Object-Oriented, Objective-C, Objective Caml, Obfuscated, Oberon, Mumps, Multiparadigm, Modula-3, Modula-2, ML, Miva, Miranda, Mercury, MATLAB, Markup, m4, Lua, Logo, Logic-based, Lisp (351), Limbo, Leda, Language-OS Hybrids, Lagoona, LabVIEW, Interpreted, Interface, Intercal, Imperative, IDL, Icl, ICI, HyperCard, HTMLScript, Haskell, Hardware Description, Goedel, Garbage Collected, Functional, Frontier, Fortran, Forth, Euphoria, Erlang, ElastiC, Eiffel, E, Dylan, DOS Batch, Directories, Declarative, Dataflow, Database, D, Curl, C-Sharp, Constraint, Concurrent, Component Pascal, Compiled, Comparison and Review, Cocoa, CobolScript, CLU, Clipper, Clean, Clarion, CHILL, Cecil, Caml, Blue, Bistro, Bigwig, BETA, Befunge, BASIC, Awk, Assembly, ASP, AppleScript, APL, Algol 88, Algol 60, Aleph, ADL, ABEL, ABC, or similar programming languages.

In an embodiment, the data storage unit or data storage device is selected from a set of but not limited to USB flash drive (pen drive), memory card, optical data storage discs, hard disk drive, magnetic disk, magnetic tape data storage device, data server and molecular memory.

The terminology used herein is for the purpose of describing particular embodiments only and is not intended to be limiting of the invention. As used herein, the singular forms “a”,“an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude or rule out the presence or addition of one or more other features, integers, steps, operations, elements, components, and/or groups thereof.

The process steps, method steps, flowcharts, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

In an embodiment of the invention the term network means a system allowing interaction between two or more electronic devices, and includes any form of inter/intra enterprise environment such as the world wide web, Local Area Network (LAN) , Wide Area Network (WAN) , Storage Area Network (SAN) or any form of Intranet.

In an example according to the embodiments of the invention, a user registers his mobile (first electronic device) and his personal computer (second electronic device) to use the encryption mechanism of the present invention.

In an example according to the embodiments of the invention, at an enterprise level, a central administrator or the CTO or any other authorized person, hereinafter referred to as ‘administrator’ is allowed to register a device, for example his mobile phone, as an authentication device for multiple websites using either the same authentication key for two or more websites. The combination of the authentication key and device based key using the encryption mechanism of the present invention becomes unique and can be authenticated only using the administrator's device, i.e. authentication will happen only when the administrator enters the correct authentication key using the registered first authentication device. After registration of authentication device, the administrator registers the various computers in the enterprise as access device with one or more websites. After registration of the access device each access device shall be using an access key, one or more of which may or may not involve the encryption mechanism based authentication. The computers which involve the encryption mechanism based authentication shall be able to access the said websites only from their registered device using the applicable access key. The administrator may optionally register the mobile phone of another authority as a second authentication device with equal rights, so that if the administrator is not available, or for backup in general, the second authentication device can control access and perform the same functions as the first access device. The administrator may optionally also register the mobile phone of a a junior authority, for example an assistant IT engineer, as a third authentication device with limited rights, so that if the administrator is not available, the third authentication device can in a limited manner control access and perform the basic functions similar to the first access device but not all the functions.

In an example according to the embodiments of the invention, at an individual level, a single user can register his authentication device and his access device for enhanced security or for convenience of use or both. The individual may use a single access key and a single device to access multiple email accounts, social networking accounts, bank accounts, online trading accounts, without having the remember separate passwords and also have enhanced security as without the authentication and access device no unauthorized user can hack the user's accounts.

In an example according to the embodiments of the invention, the encryption mechanism uses a suitable combination of the user's username, user's electronic device based unique key, the domain name of the host website for generating the encryption code.

In an example according to the embodiments of the invention, the encryption mechanism uses a suitable combination of the user's username, user's electronic device based unique key, and the domain name of the host website for generating the encryption code.

In an example according to the embodiments of the invention, the encryption mechanism uses a suitable combination of the user's username, user's electronic device based unique key, the domain name of the host website, and the host server based unique key for generating the encryption code. This kind of a system is very strong and largely eliminates the chances of the man in the middle attack.

In an example according to the embodiments of the invention, a host server uses the encryption mechanism of the present invention to enhance data security.

In an example according to the embodiments of the invention, a website provides an icon or plugin in their interface which allows a user to login or use the website through the systems or methods of the present invention, or the user may use a conventional username password system as an optional second mode of using the website.

FIG. 1 or FIG. 1 represents an illustrative example of a system diagram for the present invention involving a single user. A user (2) uses his electronic device, i.e. authentication device (1) or access device (1′) to access data through the internet or network interface (5), wherein the data is stored in a data storage device or a server (4). The access to the said data is given only after authentication is done involving the Encryption Mechanism (3) in accordance to the various embodiments of the invention. Also, the data could be accessed through a cloud computing interface (6) which may be connected to multiple servers (4′, 4″, 4′″).

FIG. 2 or FIG. 2 represents an illustrative example of the system diagram for the present invention involving a total of three users, two users (2,2′) at the client end and one user (2”) at the host server end. The example of FIG. 2. may be considered as an extension of FIG. 1, wherein in addition to the various components of FIG. 1 a second user (2′) is present that gets access to virtual data or a virtual location using an access device (1′) in accordance with the embodiments of the invention. Further, there is a user (2″) that uses a host server (4) itself as the electronic device in accordance of the invention so as to give access to virtual data and virtual location, or optionally uses another electronic device to control the server (not shown in the figure).

FIG. 3 or FIG. 3 represents a set of non-exhaustive and indicative components of the encryption mechanism (3) in accordance one or more embodiment of the present invention including an Electronic device based unique key component (7), an authentication key or an access key (8), an Encryption Algorithm (9), a Processing unit (10), a Storage Unit (11), an Encryption Code/Encrypted Authentication Code (12). In an embodiment of the invention, the Encryption algorithm (9) uses a combination of the Electronic device based unique key component (7) and an authentication key or an access key (8) to generate the Encryption Code/Encrypted Authentication Code (12). The Encryption algorithm (9) is stored in the Storage unit (11) and is processed, executed or enabled using the Processing Unit (10).

FIG. 4 or FIG. 4 represents an indicative system flow chart of an embodiment of the present invention.

In addition to the embodiments and examples shown, numerous variants are possible, which may be obvious to a person skilled in the art relating to the aspects of the invention.

1. A system for ensuring and enabling secure access to one or more virtual locations or virtual data, by a user, wherein the said systems comprise of
a) at least one authentication device; and
b) at least one secondary device, wherein the secondary device may be a second authentication device or an access device;
wherein an authentication device is associated with an authentication key which is used to generate an encrypted authentication code using a ‘unique device based encryption system and method’, the ‘unique device based encryption system and method’ comprising of a user based input; an electronic device key generated in connection with a user electronic device; and an encryption algorithm or logic or program or software which uses the user key and device key to generate an encrypted authentication code .

2. A system as claimed in claiml, comprising of an encryption mechanism which generates an encrypted authentication code, wherein the encryption mechanism comprises of:
a) an authentication key;
b) an electronic device based unique key component;
c) an encryption algorithm;
d) one or more storage unit; and
e) one or more processing unit;
wherein the encrypted authentication code is made by using a suitable combination involving both authentication key and the electronic device based unique key component.

3. A system as claimed in claim 1, wherein the electronic device is selected from a set of personal computers, mobile phones, laptops, palmtops, portable media players and personal digital assistants.

4. A system as claimed in claim 1, wherein the electronic device based unique key component is not stored in any data storage device.

5. A system as claimed in claim 1, wherein the electronic device is a host server.

6. A system as claimed in claim 1, wherein the encryption mechanism uses additional components for encryption, the components selected from but not limited to components of domain name, program seed key, voice recognition, DNA identification, eye scan, retina scan, any biometric authentication, and any combination thereof.

7. A system as claimed in claim 1, wherein multiple electronic devices are used with an encryption mechanism in addition to the said authentication device and secondary device.

8. A method for allowing a secure access control using an encryption mechanism which generates an encrypted authentication code, the method comprising of:
a) providing an authentication key by a user through an electronic device termed as ‘authentication device’ or an access key through an electronic device termed as ‘access device’;
b) acknowledging the authentication key or the access key by a processing unit;
c) using one or more properties of the electronic device or the identity of the electronic device by a processing unit to generate an electronic device based unique key component;
d) using a storage unit to temporarily store the electronic device based unique key component or authentication key or access key or a component generated in relation or the authentication key or access key, or both;
e) generating an encryption code or an encrypted authentication code by a processing unit using a suitable combination involving both, the said authentication key or access key, and the electronic device based unique key component;
f) storing the encryption code or encrypted authentication code using a storage unit; and
g) allowing the possibility of a secondary device which may be an access device or an authentication device to attempt access of one or more of virtual data or virtual location, which may be subjected to an authentication step.

9. A computer program product embodied in a computer readable medium that enables a system for ensuring and enabling secure access to one or more virtual locations or virtual data, by a user, wherein the said systems comprise of
a) at least one authentication device; and
b) at least one secondary device, wherein the secondary device may be a second authentication device or an access device;
wherein an authentication device is associated with an authentication key which is used to generate an encrypted authentication code using a ‘unique device based encryption system and method’, the ‘unique device based encryption system and method’ comprising of a user based input; an electronic device key generated in connection with a user electronic device;
and an encryption algorithm or logic or program or software which uses the user key and device key to generate an encrypted authentication code .

10. A system as claimed in claim 1, wherein the system further comprises of a decryption system and a decryption method.

11. A system as claimed in claim 1, wherein the system is practiced using electronic device which may be connected to one or more of other electronic device with wires or wirelessly which may use technologies such as but not limited to, Bluetooth, WiFi, Wimax.

12. A system as claimed in claim 2, wherein the electronic device based unique key component is deleted or removed from a storage unit instantaneously.

13. A method as claimed in claim 8, wherein the electronic device based unique key component is deleted or removed from a storage unit instantaneously.

14. A system as claimed in claim 2, wherein access key or authentication key is deleted or removed from a storage unit instantaneously.

15. A method as claimed in claim 8, wherein the electronic device based unique key component is deleted or removed from a storage unit instantaneously.
